(19) United States
(12) Patent Application Publication
(10) Pub. No.: US 2024/0332561 A1
(43) Pub. Date: Oct. 3, 2024

(54) FUEL CELL INTERCONNECT INCLUDING FUEL CHANNELS HAVING DIFFERENT CROSS-SECTIONAL AREAS

(71) Applicant: BLOOM ENERGY CORPORATION, San Jose, CA (US)

(72) Inventors: Cheng-Yu LIN, Cupertino, CA (US); Sachin PARHAR, Mumbai (IN); Annamalai RAMAN, Bangalore (IN); Sagar BONE, Mumbai (IN)

(21) Appl. No.: 18/620,347

(22) Filed: Mar. 28, 2024

(30) Foreign Application Priority Data
Mar. 31, 2023 (IN) 202341024603

(51) Int. Cl. H01M 8/0265; H01M 8/021; H01M 8/2457; H01M 8/2483

(52) U.S. Cl. CPC H01M 8/0265; H01M 8/021; H01M 8/2457; H01M 8/2483

(57) ABSTRACT

A fuel cell interconnect includes an air side and an opposing fuel side, air ribs disposed on the air side and at least partially defining air channels, and fuel ribs disposed on the fuel side and a least partially defining fuel channels. The fuel channels include central fuel channels disposed in a central fuel field, the central fuel channels having a cross-sectional area A1, peripheral fuel channels disposed in peripheral fuel fields that are disposed on opposing sides of the central fuel field, the peripheral fuel channels having a cross-sectional area A3, and intermediate fuel channels disposed in intermediate fuel fields that are disposed between the central fuel field and the peripheral fuel fields, the intermediate fuel channels having a cross-sectional area A2, where area A1<area A2<area A3.

### FIELD

The present disclosure is directed to fuel cell interconnects configured to operate in fuel cell stacks using hydrogen as a fuel, and in particular, fuel cell interconnects that include fuel channels that have different cross-sectional areas.

### BACKGROUND

A typical solid oxide fuel cell stack includes multiple fuel cells separated by metallic interconnects (ICs) which provide both electrical connection between adjacent cells in the stack and channels for delivery and removal of fuel and oxidant. The metallic interconnects are commonly composed of Cr-based alloys such as CrFe alloys, which have a composition of 95 weight percent (wt %) Cr-5 wt % Fe or Cr—Fe—Y having a 94 wt % Cr-5 wt % Fe-1 wt % Y composition. The CrFe and CrFeY alloys retain their strength and are dimensionally stable at typical solid oxide fuel cell (SOFC) operating conditions, e.g., 700-900° C. in both air and wet fuel atmospheres.

### SUMMARY

Various embodiments provide a fuel cell interconnect, comprising: an air side and an opposing fuel side; air ribs disposed on the air side and at least partially defining air channels; and fuel ribs disposed on the fuel side and a least partially defining fuel channels, the fuel channels comprising: central fuel channels disposed in a central fuel field, the central fuel channels having a cross-sectional area A1; peripheral fuel channels disposed in peripheral fuel fields that are disposed on opposing sides of the central fuel field, the peripheral fuel channels having a cross-sectional area A3; and intermediate fuel channels disposed in intermediate fuel fields that are disposed between the central fuel field and the peripheral fuel fields, the intermediate fuel channels having a cross-sectional area A2, wherein area A1<area A2<area A3.

### BRIEF DESCRIPTION OF THE DRAWINGS

FIG. 1A is a perspective view of a SOFC stack, according to various embodiments of the present disclosure.

FIG. 1B is a cross-sectional view of a portion of the stack of FIG. 1A.

FIG. 2A is a top view of an air side of an interconnect, according to various embodiments of the present disclosure.

FIG. 2B is a top view of a fuel side of the interconnect of FIG. 2A.

FIG. 3A is a top view of the fuel side of an interconnect, according to various embodiments of the present disclosure, and FIGS. 3B and 3C are cross-sectional views of fuel channels that may be included in the interconnect FIG. 3A along plane vertical X-X′ in FIG. 3A.

FIGS. 4A-4D are top views of the air sides of interconnects, according to various embodiments of the present disclosure.

### DETAILED DESCRIPTION

The various embodiments will be described in detail with reference to the accompanying drawings. The drawings are not necessarily to scale and are intended to illustrate various features of the invention. Wherever possible, the same reference numbers will be used throughout the drawings to refer to the same or like parts. References made to particular examples and implementations are for illustrative purposes and are not intended to limit the scope of the invention or the claims.

Ranges can be expressed herein as from “about” one particular value, and/or to “about” another particular value. When such a range is expressed, examples include from the one particular value and/or to the other particular value. Similarly, when values are expressed as approximations, by use of the antecedent “about” or “substantially” it will be understood that the particular value forms another aspect. In some embodiments, a value of “about X” may include values of +/−1% X. It will be further understood that the endpoints of each of the ranges are significant both in relation to the other endpoint, and independently of the other endpoint.

In a high temperature fuel cell system, such as a solid oxide fuel cell (SOFC) system, an oxidizing flow is directed to the cathode side of the fuel cell while a fuel flow is directed to the anode side of the fuel cell. The oxidizing flow is typically air, while the fuel flow can be hydrogen (H₂). The fuel cell, operating at a typical temperature between 750° C. and 950° C., provides the transport of negatively charged oxygen ions from the cathode flow stream to the anode flow stream, where the ions combine with free hydrogen to form water vapor and/or with carbon monoxide to form carbon dioxide. The excess electrons from the negatively charged ions are routed back to the cathode side of the fuel cell through an electrical circuit completed between anode and cathode, resulting in an electrical current flow through the circuit.

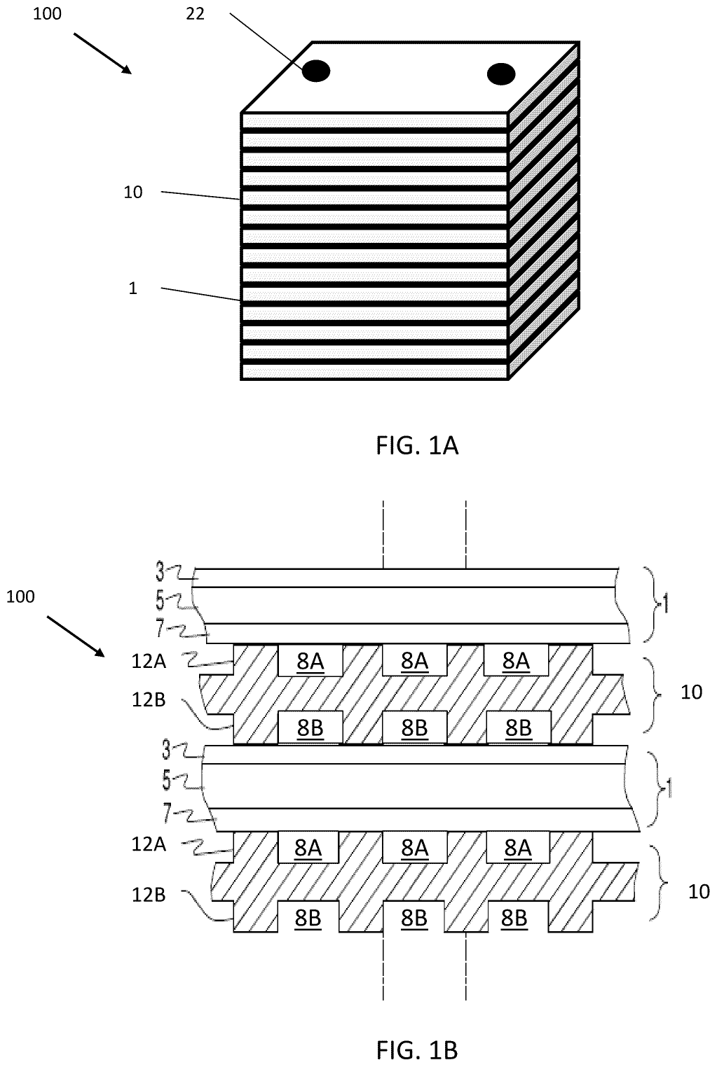

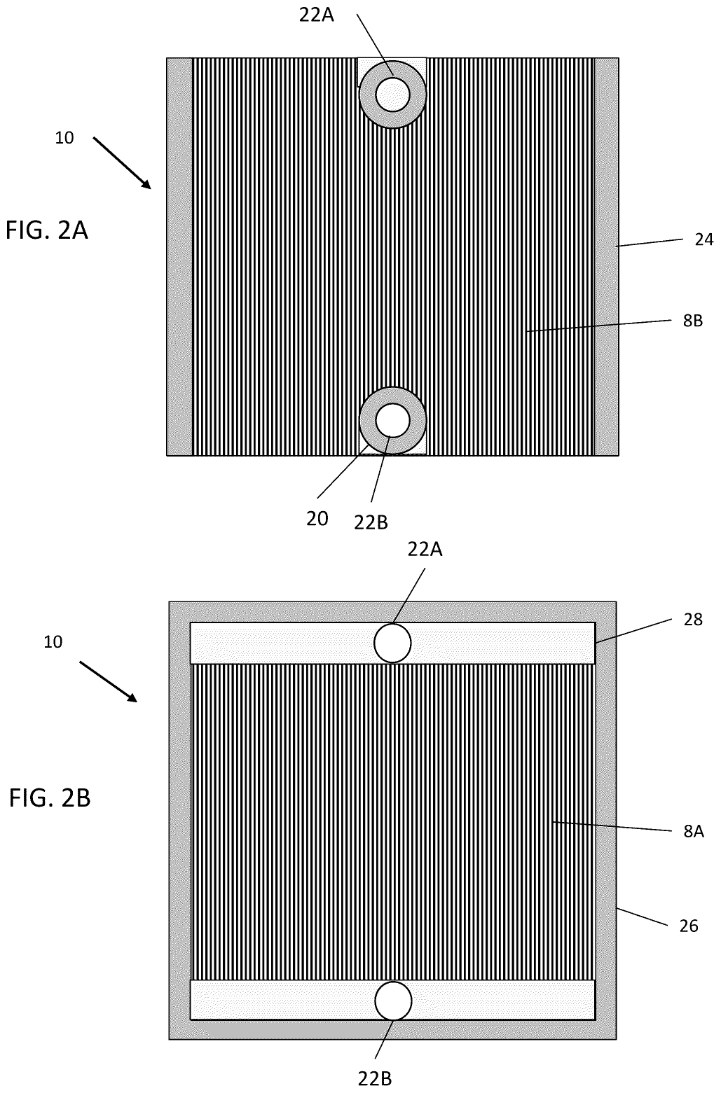

FIG. 1A is a perspective view of a solid oxide fuel cell (SOFC) stack 100, and FIG. 1B is a sectional view of a portion of the stack 100, according to various embodiments of the present disclosure. Referring to FIGS. 1A and 1B, the stack 100 includes fuel cells 1 separated by interconnects 10. Referring to FIG. 1B, each fuel cell 1 comprises a cathode electrode 3, a solid oxide electrolyte 5, and an anode electrode 7.

Various materials may be used for the cathode electrode 3, electrolyte 5, and anode electrode 7. For example, the anode electrode 7 may comprise a cermet comprising a nickel containing phase and a ceramic phase. The nickel containing phase may consist entirely of nickel in a reduced state. This phase may form nickel oxide when it is in an oxidized state. Thus, the anode electrode 7 is preferably annealed in a reducing atmosphere prior to operation to reduce the nickel oxide to nickel. The nickel containing phase may include other metals in additional to nickel and/or nickel alloys. The ceramic phase may comprise a stabilized zirconia, such as yttria and/or scandia stabilized zirconia and/or a doped ceria, such as gadolinia, yttria and/or samaria doped ceria.

The electrolyte 5 may comprise a stabilized zirconia, such as scandia stabilized zirconia (SSZ) or yttria stabilized zirconia (YSZ). Alternatively, the electrolyte may comprise another ionically conductive material, such as a doped ceria.

The cathode electrode 3 may comprise an electrically conductive material, such as an electrically conductive perovskite material, such as lanthanum strontium manganite (LSM). Other conductive perovskites, such as LSCo, etc., or metals, such as Pt, may also be used. The cathode electrode 3 may also contain a ceramic phase similar to the anode electrode 7. The electrodes and the electrolyte may each comprise one or more sublayers of one or more of the above described materials.

Fuel cell stacks are frequently built from a multiplicity of SOFC's 1 in the form of planar elements, tubes, or other geometries. Although the fuel cell stack in FIG. 1A is vertically oriented, fuel cell stacks may be oriented horizontally or in any other direction. Fuel and air may be provided to the electrochemically active surfaces, which can be large. For example, fuel may be provided through fuel conduits 22 (e.g., fuel riser openings) formed in each interconnect 10.

Each interconnect 10 electrically connects adjacent fuel cells 1 in the stack 100. In particular, an interconnect 10 may electrically connect the anode electrode 7 of one fuel cell 1 to the cathode electrode 3 of an adjacent fuel cell 1. FIG. 1B shows that the lower fuel cell 1 is located between two interconnects 10. An optional Ni mesh may be used to electrically connect the interconnect 10 to the anode electrode 7 of an adjacent fuel cell 1.

Each interconnect 10 includes fuel ribs 12A that at least partially define fuel channels 8A and air ribs 12B that at least partially define oxidant (e.g., air) channels 8B. The interconnect 10 may operate as a gas-fuel separator that separates a fuel, such as a hydrocarbon fuel, flowing to the fuel electrode (i.e., anode 7) of one cell in the stack from oxidant, such as air, flowing to the air electrode (i.e., cathode 3) of an adjacent cell in the stack. At either end of the stack 100, there may be an air end plate or fuel end plate (not shown) for providing air or fuel, respectively, to the end electrode.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may comprise a metal (e.g., a chromium-iron alloy, such as 4-6 weight percent iron, optionally 1 or less weight percent yttrium and balance chromium alloy) and may electrically connect the anode or fuel-side of one fuel cell 1 to the cathode or air side of an adjacent fuel cell 1. An electrically conductive contact layer, such as a nickel contact layer, may be provided between anode electrodes 7 and each interconnect 10. Another optional electrically conductive contact layer, such as a lanthanum strontium manganite and/or a manganese cobalt oxide spinel layer, may be provided between the cathode electrodes 3 and each interconnect 10.

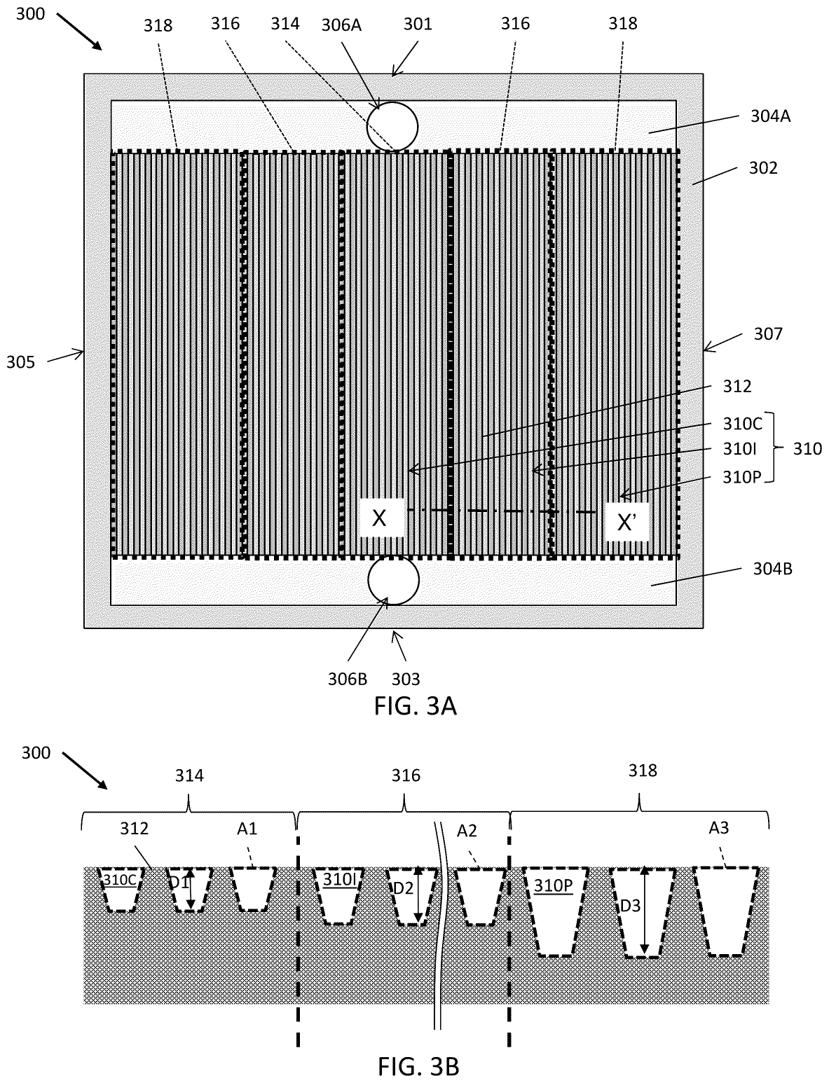

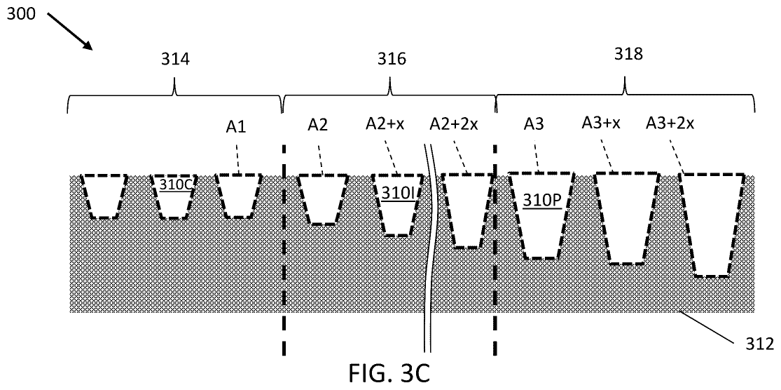

FIG. 2A is a top view of the air side of the interconnect 10, and FIG. 2B is a top view of a fuel side of the interconnect 10, according to various embodiments of the present disclosure. Referring to FIGS. 1B and 2A, the air side includes the air channels 8B. Air flows through the air channels 8B to a cathode electrode 3 of an adjacent fuel cell 1. Ring seals 20 may surround fuel holes 22A and 22B of the interconnect 10, to prevent fuel from contacting the cathode electrode. Peripheral strip-shaped seals 24 are located on peripheral portions of the air side of the interconnect 10. The seals 20, 24 may be formed of a glass or glass-ceramic material. The peripheral portions may be an elevated plateau which does not include ribs or channels. The surface of the peripheral regions may be coplanar with tops of the ribs 12B.

Referring to FIGS. 1B and 2B, the fuel side of the interconnect 10 may include the fuel channels 8A and fuel manifolds 28. Fuel flows from one of the fuel holes 22A (e.g., inlet hole that forms part of the fuel inlet riser), into the adjacent manifold 28, through the fuel channels 8A, and to an anode 7 of an adjacent fuel cell 1. Excess fuel may flow into the other fuel manifold 28 and then into the outlet fuel hole 22B. A frame-shaped seal 26 is disposed on a peripheral region of the fuel side of the interconnect 10. The peripheral region may be an elevated plateau which does not include ribs or channels. The surface of the peripheral region may be coplanar with tops of the ribs 12A.

As shown in FIGS. 2A and 2B, one of the fuel holes 22A, 22B delivers fuel to each cell in the stack and a corresponding manifold 28 distributes fuel to each fuel channel 8A. Fuel flows straight down each fuel channel 8A, and unreacted fuel is collected in the other manifold 28 and exits the stack via the other fuel hole 28A, 28B. This flow channel geometry is optimized for operation using natural gas with partial external pre-reforming.

The present inventors found that while the interconnect 10 shown in FIGS. 2A and 2B provides a high fuel utilization when a hydrocarbon fuel (e.g., natural gas) is used, the interconnect 10 may not provide a sufficiently high fuel utilization when hydrogen is used as a fuel. Without wishing to be bound by a particular theory, it is believed that using hydrogen as a fuel produces an increased thermal gradient. For example, in a natural gas-fueled SOFC system, an endothermic steam reformation reaction occurs at the anode and partially cools the interconnect 10 and adjacent fuel cells 1. However, with a pure hydrogen fuel, no reformation cooling occurs, and most of the heat generated by the fuel cell is removed by reactant flow (e.g., primarily air flow). As a result, operating using hydrogen may lead to high thermal gradients across fuel cells 1 and interconnects 10, between the fuel inlet hole 22A and the fuel outlet hole 22B and/or between adjacent corners of the interconnects 10 and/or fuel cells 1. Such thermal gradients may result in coefficient of thermal expansion (CTE) mismatches between fuel cells 1 and interconnects 10, which may damage the seals 20, 24, 26, and/or fuel cells 1 over time. Further, hydrogen operation generates higher temperatures than methane operation, and corresponding higher CTE mismatches between the interconnect 10 and adjacent fuel cells 1.

According to various embodiments, interconnects are configured to reduce thermal gradients when used in a fuel cell stack which operates on hydrogen fuel. For example, various embodiments provide air side and/or fuel side structures configured to reduce thermal gradients and CTE mismatch in fuel cell stacks using hydrogen fuel. In some embodiments, the thermal gradient may be reduced by increasing fuel and/or air flow velocities along particular regions of an interconnect, to reduce the temperature of the regions.

The fuel channel geometry of conventional interconnects is designed to provide a fuel mass flow rate that maximizes the utilization rate of hydrocarbon fuels, such as natural gas. However, carbon-free hydrogen gas has a much lower mass than such carbon-containing fuels. As such, the fuel channel geometry of conventional interconnects may supply more hydrogen than can be consumed by an adjacent fuel cell, which results in a low fuel utilization rate.

According to various embodiments, interconnects are configured to provide reduced mass flow rates that increase the fuel utilization rate of hydrogen fuel. In particular, interconnects of the present disclosure have fuel channel geometries designed to provide a reduced fuel mass flow rate as compared to conventional interconnects, while providing substantially the same fuel velocity.

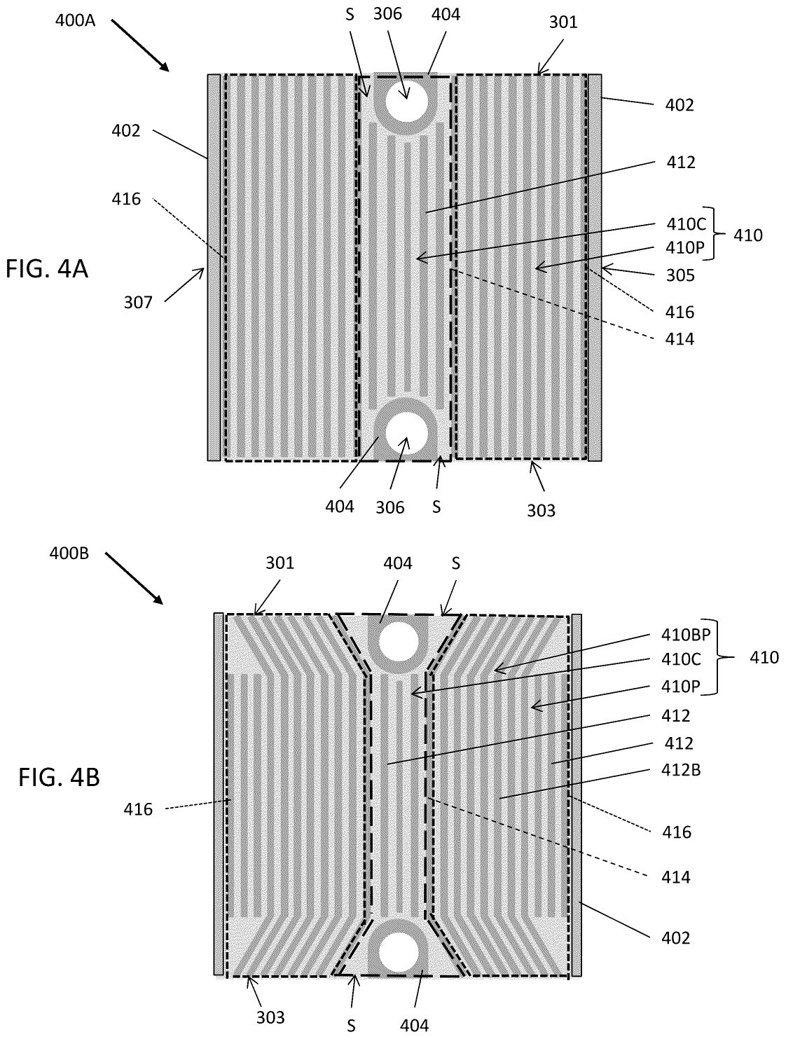

FIG. 3A is a top view of the fuel side of an interconnect 300, according to various embodiments of the present disclosure, and FIG. 3B is a cross-sectional view showing fuel channels of fuel fields of the interconnect 300 of FIG. 3A along vertical plane X-X′ in FIG. 3A. The interconnect 300 may be similar to the interconnect 10. As such, only the differences therebetween will be discussed in detail.

Referring to FIGS. 3A and 3B, the fuel-side of the interconnect 300 may include a frame seal region 302, a fuel inlet manifold 304A, a fuel outlet manifold 304B, a fuel inlet hole 306A, a fuel outlet hole 306B, fuel ribs 312, and fuel channels 310. The frame seal region 302 may be a planar surface that extends along the perimeter of the interconnect 300. The frame seal region 302 may be coplanar with the tops of the fuel ribs 312. The fuel manifolds 304A, 304B may be disposed inside of the frame seal region 302, at opposing edges 301, 303 of the interconnect 300. The fuel holes 306A, 306B may be formed in the center of each of the fuel manifolds 304A, 304B, adjacent to opposing first and second edges 301, 303 of the interconnect 300.

The fuel ribs 312 and fuel channels 310 may extend between the fuel manifolds 304A, 304B in a direction parallel to opposing third and fourth edges 305, 307 of the interconnect 300. The fuel channels 310 and fuel ribs 312 may be configured to guide fuel flow across the interconnect 300 between the fuel inlet and outlet manifolds 304A, 304B. The interconnect 300 may be divided into a central fuel field 314, intermediate fuel fields 316, and peripheral fuel fields 318. The central fuel field 314 may be disposed between the fuel holes 306A and 306B. The peripheral fuel fields 318 may be disposed on opposing sides of the central fuel field 314, adjacent to the third and fourth edges 305, 307. The intermediate fuel fields 316 may be disposed between the central fuel field 314 and the peripheral fuel fields 318.

The fuel channels 310 may include central fuel channels 310C disposed in the central fuel field 314, intermediate fuel channels 310I disposed in the intermediate fuel fields 316, and peripheral fuel channels 310P disposed in the peripheral fuel fields 318. A relatively low number of fuel channels is shown for clarity in FIG. 3A, and the number of fuel channels in the interconnect 300 may be greater than that shown in FIG. 3A. In various embodiments, the interconnect 300 may include from 8 to 14, such as from 10 to 12 of the central fuel channels 310C, from 12 to 24, such as from 16 to 20 of the intermediate fuel channels 310I, and from 18 to 30, such as from 22 to 26 of the peripheral fuel channels 310P. The interconnect 300 may include equal numbers of the intermediate fuel channels 310I in each intermediate fuel field 316 and may include equal numbers of the peripheral fuel channels 310P in each peripheral fuel field 318 located on opposing sides of the central fuel field 314. However, the present disclosure is not limited to any particular number of fuel channels in a given fuel field.

Fuel pressure in the fuel inlet manifold 304A may decrease as distance from the fuel inlet hole 306A increases. As such, fuel may be provided to the central fuel channels 310C at a higher pressure than to the intermediate and/or peripheral fuel channels 310I, 310P. However, the fuel channels 310 may be configured such that fuel flows through each fuel channel 310 at a substantially uniform fuel mass flow rate. In particular, the cross-sectional area and/or pitch of the fuel channels 310 may be adjusted to provide a substantially consistent mass flow rate through the fuel channels 310. For example, the cross-sectional areas of the fuel channels 310 may be modified by adjusting, for example, one or more channel dimensions, such as channel width and/or channel depth, to adjust the channel cross-sectional area.

According to various embodiments, the depths of one or more of the fuel channels 310 may be varied, in order to modify the cross-sectional areas thereof. For example, in various embodiments, the central fuel channels 310C may have a first depth D1 and a corresponding first cross sectional area A1, the intermediate fuel channels 310I may have a second depth D2 and a corresponding second cross-sectional area A2, and the peripheral fuel channels 310P may have a third depth D3 and a third cross-sectional area A3, wherein D1<D2<D3 and A1<A2<A3.

In some embodiments, the third area A3 may range from about 0.275 mm² to about 0.325 mm², such as from about 0.285 mm² to about 0.315 mm², from about 0.295 mm² to about 0.305 mm². The second area A2 may range from about 0.235 mm² to about 0.285 mm², such as from about 0.245 mm² to about 0.275 mm², from about 0.255 mm² to about 0.265 mm². The first area A1 may range from about 0.190 mm² to about 0.240 mm², such as from about 0.200 mm² to about 0.230 mm², from about 0.210 mm² to about 0.220 mm².

In various embodiments, a ratio of A2/A3 may range from about 0.860 to about 0.910, such as from about 0.870 to about 0.9, from about 0.880 to about 0.890, or about 0.885. A ratio of A1/A3 may range from about 0.705 to about 0.775, such as from about 0.715 to about 0.755, from about 0.725 to about 0.735, or about 0.730. A ratio of A1/A2 may range from about 0.800 to about 0.860, such as from about 0.810 to about 0.850, from about 0.820 to about 0.830, or about 0.825.

For example, D1 may range from about 0.25 mm to about 0.35 mm, such as from about 0.3 mm to about 0.32 mm. D2 may range from about 0.3 mm to about 0.45 mm, such as from about 0.32 mm to about 0.37 mm. D3 may range from about 0.35 mm to about 0.55 mm, such as from about 0.37 mm to about 0.43 mm.

Accordingly, the relatively small first cross-sectional area, in conjunction with the relatively high inlet fuel pressure, may result in the central fuel channels 310C having a relatively high fuel velocity V1 during stack operation. The relatively large third cross-sectional area, in conjunction with the relatively low fuel inlet pressure, may result in the peripheral fuel channels 310C having a relatively low fuel velocity V3 during stack operation. For similar reasons, the intermediate fuel channels 310I may have an intermediate fuel velocity V2 during stack operation that is between the first fuel velocity and the third fuel velocity. In other words, velocity V1>velocity V2>velocity V3.

However, the above fuel velocity and cross-sectional area variations may result substantially the same fuel mass flow rate through each of the fuel channels 310. In particular, the fuel channels 310 may be configured such that a fuel mass flow rate through each fuel channel 310 varies by +/−5% or less, such as by +/−4% or less, +/−3% or less, +/−2% or less, or +/−0 to 1%.

In addition, the fuel velocity variations may result in reduced temperature variation across the interconnect 300. For example, the high fuel velocity V1 through the central fuel channels 310C, the intermediate fuel velocity V2 through the intermediate fuel channels 310I, and the low fuel velocity V3 through the peripheral fuel channels 310P may result in relatively high, intermediate, and low amounts of temperature reduction in the central fuel field 314, the intermediate fuel fields 316, and the peripheral fuel fields 318, respectively. In other words, the central fuel channels 310C may be configured to provide the highest amount of cooling due to the highest fuel velocity V1 to the central portion of the interconnect 300 where the most heat is generated by reactions at an adjacent fuel cell. In contrast, the peripheral fuel channels 310P may be configured to provide the lowest amount of cooling due to the lowest fuel velocity V3 to the peripheral portions of the interconnect 300 where the least heat is generated by reactions at an adjacent fuel cell. This reduces the thermal gradients across the interconnect 300 and the adjacent fuel cell, and reduces the CTE mismatch and damage to the fuel cell.

FIG. 3C is a cross-sectional view showing an alternative fuel channel configuration that may be included in the interconnect 300 of FIG. 3A, according to various embodiments of the present disclosure. Referring to FIGS. 3A and 3C, the central fuel channels 310C may have substantially the same cross-sectional area A1. The intermediate fuel channels 310I may have increasing cross-sectional areas with distance from the central fuel channels 310C. For example, the intermediate fuel channel 310I closest to the central fuel field 314 may have a cross-sectional area A2, the next adjacent intermediate channel 310I may have a larger cross-sectional area A2+x, and the next adjacent intermediate fuel channel 310I may have a larger cross-sectional area A2+2x, etc., where x is a positive number.

Similarly, the cross-sectional areas of the peripheral fuel channels 310P may gradually increase as distance from the central fuel field 314 increases. For example, the peripheral fuel channel 310P closest to the intermediate fuel field 316 may have a cross-sectional area A3, the next adjacent peripheral fuel channel 310P may have a larger cross-sectional area A3+x, and the next adjacent peripheral fuel channel 310I may have a larger cross-sectional area A3+2x, etc., where x is a positive number.

Accordingly, the central fuel channels 310C may have substantially the same cross-sectional area, and the cross-sectional areas of the intermediate and peripheral fuel channels 310I, 310P may continuously increase as a distance to the central fuel field 314 increases.

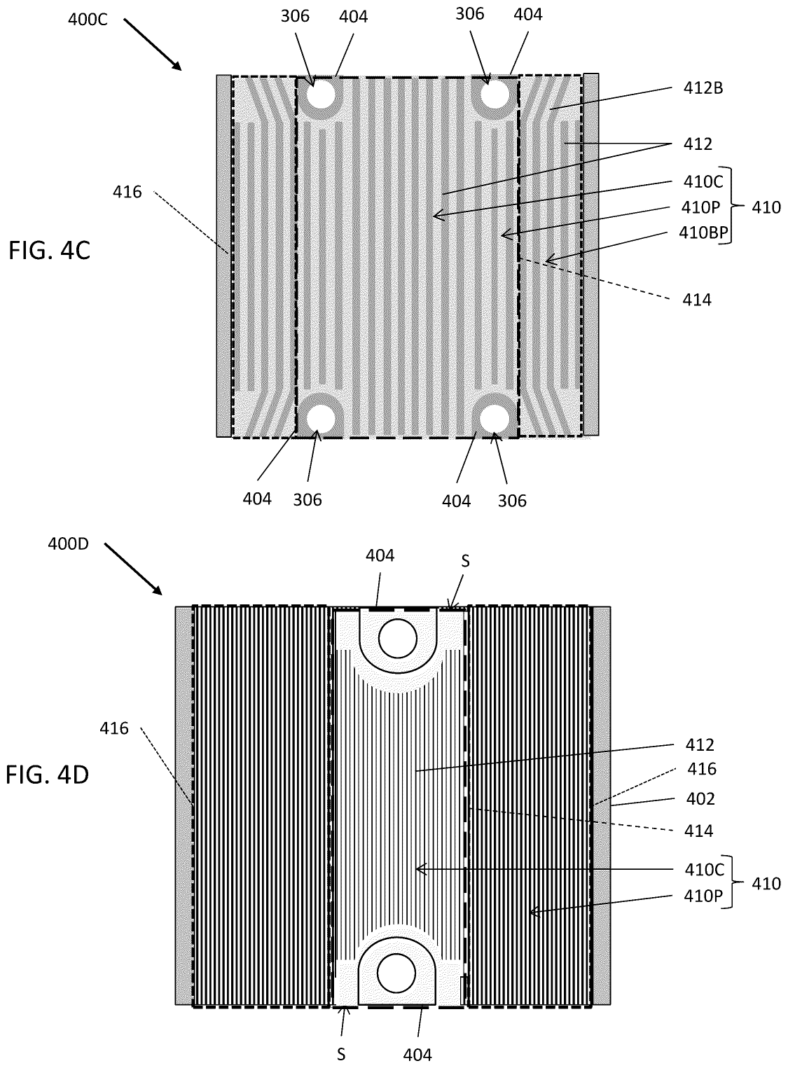

FIG. 4A is a top view of the air side of an interconnect 400A, according to various embodiments of the present disclosure. Referring to FIG. 4A, the airside of the interconnect 400A may include strip seal regions 402, ring seal regions 404, air (e.g., oxidant) channels 410, air ribs 412, and fuel holes 306. The ring seal regions 404 may be planar regions that surround the fuel holes 306. The strip seal regions 402 may be planar regions disposed on opposing edges of the interconnect 400A. The ring seal regions 404 and the strip seal regions 402 may be coplanar with the tops of the air ribs 412.

The air ribs 412 may at least partially define the air channels 410. The air channels 410 may be configured to guide air across the interconnect between the strip seal regions 402. The air side of the interconnect 400A may be divided into a central air field 414 and peripheral air fields 416 that are disposed on opposing sides of the central air field 414, adjacent to third and fourth edges 305, 307 of the interconnect 400A. The air channels 410 may include central air channels 410C disposed in the central air field 414 and peripheral air channels 410P disposed in the peripheral air fields 416.

In one embodiment, all air channels 410 may have a larger cross-sectional area than the air channels 8B of the comparative interconnect 10 shown in FIG. 2A. This increases the air cooling of the air side of the interconnect 400A when hydrogen is used as a fuel in the fuel side of the interconnect 400A.

In another embodiment, the cross-sectional areas of the central air channels 410C may be larger than the cross-sectional areas of the peripheral air channels 410P of interconnect 400A. For example, the central air channels 410C may be wider and/or deeper than the peripheral air channels 410P. In some embodiments, the cross-sectional areas of the central air channels 410C may be from 5% to 40%, such as from 8% to 30%, or from 10% to 20% larger than the cross-sectional areas of the peripheral air channels 410P. As such, air mass flows through the central air channels 410C may be correspondingly larger than air mass flows through the peripheral air channels 410P. More air mass flow in the central air channels 410C increases cooling of the center of an adjacent fuel cell and reduces thermal gradients in the fuel cell and the interconnect 400A when hydrogen is used as a fuel.

In some embodiments, the cross-sectional areas of the air channels 410 may increase continuously or stepwise as distance to the adjacent third and fourth edges 305, 307 decreases. In some embodiments, the cross-sectional areas of the central air channels 410C may vary incrementally, such that the central air channels 410C closer to the middle of the central air field 414 may have larger cross-sectional areas than central air channels 410C disposed closer to the peripheral air fields 416. However, in various embodiments, at least some of the central air channels 410C may have larger cross-sectional areas than the peripheral air channels 410P.

In some embodiments, the air ribs 412 located in the central air field 414 adjacent to the ring seal regions 404 may be relatively short in length (i.e., shorter than the air ribs 412 located in the peripheral air field 416), to provide air spaces S to increase air flow around the ring seal regions 404 and thereby increase air mass flows through the central air channels 410C extending between the ring seal regions 404 on the opposite side of the interconnect 400A. In other words, at least some of the air ribs 412 in the central air field 414 may be shorter in length than the remaining air ribs 412, in order to increase air flow through the central air channels 410C in the central air field 414, thereby increasing cooling of corresponding portions of the interconnect 400A and an adjacent fuel cell. In some embodiments in which the air ribs 412 have a different length in the central and peripheral air fields, the cross-sectional areas of the central air channels 410C may be larger than the cross-sectional areas of the peripheral air channels 410P, in order to further increase air mass flow through the central air channels 410C of the central air field 414. In other embodiments, the cross-sectional areas of the central air channels 410C may the same as the cross-sectional areas of the peripheral air channels 410P.

FIG. 4B is a top view of the air side of an interconnect 400B, according to various embodiments of the present disclosure. The interconnect 400B may be similar to the interconnect 400A. As such, only the differences therebetween will be discussed in detail.

Referring to FIG. 4B, the air side of the interconnect 400B may include curved or bent peripheral air channels 410BP and corresponding curved or bent air ribs 412B. In particular, end portions of the bent air ribs 412B may be shaped so as to form air spaces S adjacent to the ring seal regions 404. In other words, edge portions of the bent peripheral air channels 410BP located near the edges 301 and 303 of the interconnect 400B are not parallel to the edges 305 and 307 of the interconnect and are not parallel to the central air channels 410C. For example, edge portions of the bent peripheral air channels 410BP located near the edges 301 and 303 of the interconnect 400B extend at an angle of 30 to 60 degrees relative to the edges 305 and 307 of the interconnect and to the central air channels 410C. In contrast, middle portions the bent peripheral air channels 410BP at the middle of the interconnect 400B are parallel to the edges 305 and 307 of the interconnect and the central air channels 410C.

The air spaces S may be configured to increase air mass flow into the central channels 410C of the central air field 414. In particular, the spaces S may operate to compensate for air blockage resulting from the ring seal regions 404. The bent air ribs 412B may also be configured to reduce air mass flow through peripheral air channels 410P adjacent to the strip seal regions 402. For example, the end portions of the bent air ribs 412B may partially block air flow to the outermost peripheral air channels 410P.

In some embodiments, the cross-sectional areas of the central air channels 410C may be larger than the cross-sectional areas of the peripheral air channels 410P, in order to further increase air mass flow through the central air channels 410C of the central air field 414 of interconnect 400B. In other embodiments, the cross-sectional areas of the central air channels 410C may the same as the cross-sectional areas of the peripheral air channels 410P of interconnect 400B.

FIG. 4C is a top view of the air side of an interconnect 400C, according to various embodiments of the present disclosure. The interconnect 400C may be similar to the interconnect 400B. As such, only the differences therebetween will be discussed in detail.

Referring to FIG. 4C, the airside of the interconnect 400C may include multiple fuel holes 306 and ring seal regions 404 disposed on opposing top and bottom sides of the interconnect 400C. The ring seal regions 404 may be disposed on peripheral edges of the central air field 414 such that the inner-most central air channels 410C of the central air field 414 are not obstructed by the fuel seals. As such, air mass flow through the central air field 414 may be increased.

In some embodiments, the cross-sectional areas of the central air channels 410C may be larger than the cross-sectional areas of the peripheral flow channels 410P, in order to further increase air flow through the central air channels 410C. However, in other embodiments, all the air channels 410 may have substantially the same cross-sectional area.

FIG. 4D is a top view of the air side of an interconnect 400D, according to various embodiments of the present disclosure. The interconnect 400D may be similar to the interconnect 400A. As such, only the differences therebetween will be discussed in detail.

Referring to FIG. 4D, at least some of the central air channels 410C may be shorter in length than the peripheral air channels 410P. Furthermore, the central air channels 410 in the middle of the central air field 414 maybe shorter in length than the central air channels 410 at the peripheral parts of the central air field 414. Furthermore, the central air channels 410 in the middle of the central air field 414 may have an increasing length (in the direction between the ring seal regions 404) as a function of distance from the middle of the interconnect 400D. For example, the edges of the central air channels 410 in the middle of the central air field 414 may form a semi-circular shape around the ring seal regions 404. In contrast, the central air channels 410 at the peripheral parts of the central air field 414 may have the same length and their edges facing the interconnect 400D edges 301 and 303 form a straight line.

In particular, air spaces S may be formed around the ring seal regions 404 due the shorter length of air ribs 412 in the central air field 414. The air spaces S are located between the air ribs 412 in the peripheral air fields 416 and the ring seal regions 404. The air spaces S may be configured to increase air mass flow through the central air channels 410C, by providing additional space for air to flow around the ring seal regions 404. The spaces S may also reduce air mass flow variation among the central air channels 410C. For example, air mass flow through variation between the central air channels 410C may be less than 25%, such as 20 to 25%. Furthermore, the air flow through the central air channels 410C may be at least 25% greater, such as 30 to 35% greater than through the peripheral flow channels 410P.

In some embodiments, the cross-sectional areas of the central air channels 410C may be larger than the cross-sectional areas of the peripheral air flow channel 410P, in order to further increase air flow through the central air flow channels 410C. However, in other embodiments, all the air flow channels 410 may have substantially the same cross-sectional area.

Referring to FIGS. 3A-3C and 4A-4D, various embodiments may include interconnects having any combination of the described air and fuel side features. For example, the interconnect 300 may include any of the air side features shown in FIGS. 4A-4D, and the interconnects 400A-400D may include any of the fuel side features shown in FIGS. 3A-3C.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. A fuel cell interconnect, comprising:
an air side and an opposing fuel side;
air ribs disposed on the air side and at least partially defining air channels; and
fuel ribs disposed on the fuel side and a least partially defining fuel channels, the fuel channels comprising:
central fuel channels disposed in a central fuel field, the central fuel channels having a cross-sectional area A1;
peripheral fuel channels disposed in peripheral fuel fields that are disposed on opposing sides of the central fuel field, the peripheral fuel channels having a cross-sectional area A3; and
intermediate fuel channels disposed in intermediate fuel fields that are disposed between the central fuel field and the peripheral fuel fields, the intermediate fuel channels having a cross-sectional area A2,
wherein area A1<area A2<area A3.

2. The interconnect of claim 1, wherein:
area A3 ranges from about 0.275 mm² to about 0.325 mm²;
area A2 ranges from about 0.235 mm² to about 0.285 mm²; and
area A1 ranges from about 0.190 mm² to about 0.240 mm².

3. The interconnect of claim 1, wherein:
area A3 ranges from about 0.295 mm² to about 0.305 mm²;
area A2 ranges from about 0.255 mm² to about 0.265 mm²; and
area A1 ranges from about 0.210 mm² to about 0.220 mm².

4. The interconnect of claim 1, wherein:
a ratio of area A2 to area A3 ranges from about 0.860 to about 0.910;
a ratio of area A1 to area A3 ranges from about 0.705 to about 0.755; and
ratio of area A1 to area A2 ranges from about 0.800 to about 0.860.

5. The interconnect of claim 1, wherein:
a ratio of area A2 to area A3 ranges from about 0.880 to about 0.890;
a ratio of area A1 to area A3 ranges from about 0.725 to about 0.735; and
ratio of area A1 to area A2 ranges from about 0.820 to about 0.830.

6. The interconnect of claim 1, wherein the interconnect comprises:
from 8 to 14 of the central fuel channels;
from 12 to 24 of the intermediate fuel channels in each of the intermediate fuel fields; and
from 18 to 30 of the peripheral fuel channels in each of the peripheral fuel fields.

7. The interconnect of claim 1, wherein the interconnect comprises:
from 10 to 12 of the central fuel channels;
from 16 to 20 of the intermediate fuel channels in each of the intermediate fuel fields; and
from 22 to 26 of the peripheral fuel channels in each of the peripheral fuel fields.

8. The interconnect of claim 1, wherein the interconnect comprises:
an equal number of the intermediate fuel channels in each intermediate fuel field; and
an equal number of the peripheral fuel channels in each peripheral fuel field.

9. The interconnect of claim 1, wherein:
the central fuel channels have a depth D1;
the intermediate fuel channels have a depth D2; and
the peripheral fuel channels have a depth D3; and
depth D1<depth D2<depth D3.

10. The interconnect of claim 1, wherein the interconnect further comprises:
fuel inlet and outlet manifolds located on the fuel side of the interconnect and fluidly connected to respective opposing ends of the fuel channels; and
fuel holes that are disposed in the fuel inlet and outlet manifolds and that extend through the interconnect.

11. The interconnect of claim 10, wherein the fuel channels are configured such that fuel provided to the fuel channels from the fuel inlet manifold flows through each of the fuel channels at a mass flow rate that varies by less than +/−5%.

12. The interconnect of claim 10, wherein:
the fuel channels are configured such that fuel provided to the fuel channels from the fuel inlet manifold flows through the central fuel channels at a velocity V1, flows through the intermediate channels at a velocity of V2, and flows through the peripheral channels at a velocity V3; and
velocity V1>velocity V2>velocity V3.

13. The interconnect of claim 10, wherein the peripheral fuel channels continuously increase in depth in a direction away from the central fuel field, and the intermediate fuel channels continuously increase in depth in a direction away from the central fuel field.

14. The interconnect of claim 1, wherein the interconnect comprises a chromium iron alloy comprising from 4 wt % to 6 wt % iron and 94 wt % to 96 wt % chromium.

15. The interconnect of claim 1, wherein:
the air channels comprise central air channels disposed in a central air field and peripheral air channels disposed in peripheral air fields disposed on opposing sides of the central air field; and
the central air channels have at least one of a different cross-sectional area or length than the peripheral air channels to increase air flow through the central air channels.

16. The interconnect of claim 15, wherein the central air channels have larger cross-sectional areas than the peripheral air channels.

17. The interconnect of claim 15, wherein the peripheral air channels have longer lengths than the central air channels.

18. A fuel cell stack comprising solid oxide fuel cells separated by interconnects of claim 1.

19. A method of operating the fuel cell stack of claim 18, comprising:
providing hydrogen fuel into the fuel channels, wherein the hydrogen fuel flows through the central fuel channels at a velocity V1, flows through the intermediate fuel channels at a velocity V2, and flows through the peripheral fuel channels at a velocity V3, wherein velocity V1>velocity V2>velocity V3; and
providing air into the air channels.

20. The method of claim 19, wherein:
the air channels comprise central air channels disposed in a central air field and peripheral air channels disposed in peripheral air fields disposed on opposing sides of the central air field; and
the providing air to the air channels comprises providing more air to the central air channels than to the peripheral air channels.
